(19) United States
(12) Patent Application Publication
(10) Pub. No.: US 2005/0133230 A1
(43) Pub. Date: Jun. 23, 2005

(54) Hand held garden tool and method for making the same

(76) Inventors: Kelly C. Sheehan, Mercer Island, WA (US); Michael O. Roser, Bellevue, WA (US)

Correspondence Address: Robert M. Storwick, PO Box 386, Mercer Island, WA, 98040, US

(21) Appl. No.: 10/745,416

(22) Filed: Dec. 23, 2003

(51) Int. Cl. A01B 1/00

(52) U.S. Cl. 172/378

(57) ABSTRACT

A multipurpose tool for indoor or outdoor gardening, planting, and soil working, and a method for making the same, are disclosed. The tool and method incorporate the capabilities of scooping, cutting, scraping, loosening, working, furrowing, trenching, digging, removing, and replacing kitchen commodities, household dirt or garden soil; of setting and removing plants; of weeding; and of cutting and removing plant roots and other obstacles found in or around soil. Preferred embodiments of the tool aspect of the invention provide a generally dished blade with a bifurcated pointed tip. At least one serrated blade edge for cutting of roots and other obstacles or debris is provided. The method includes a procedure for loosening, furrowing, digging, and excavating soil with a single tool.

### TECHNICAL FIELD

The present invention relates to garden tools and methods for making the same, and more particularly, to a hand held garden tool and methods for making the same.

### BACKGROUND OF THE INVENTION

Hand held tools have progressed over the centuries from those of the rudest quality, such as sticks dragged upon the ground for plows, to bladed shovels and spades, shears, hammers, chisels, knives, forks and spoons. Always each tool had but a single job: the shovel and the spade to replace the hands in digging; the hoe and the plow to take the place of sticks for furrowing and breaking the soil; and shears, saws, and clippers to take up cutting of vegetation. In the home and in the kitchen, it has been much the same: kitchen implements replaced the ruder functions of fingers and teeth for eating and cutting, and of sticks for stirring. Thus, one who worked the soil needed constantly at hand a variety of instruments: for farming, a plow, a harvester, a shovel, a scythe, a baler, a pitchfork; for gardening, a shovel, a rake, a spade, a trowel, a hoe, a pair of clippers, and occasionally a saw or knife. In the house, the variety has been less, but the utility has not been there either.

Development has been slow. Even today, with the integration of gasoline engines and electric motors, it is the rule that one tool performs one job; and the job that tool does has been done in essentially the same way by essentially identical tools for many hundreds of years. At most, the tool differs from its predecessors only in its source of power: tractors tow plows essentially identical to those of ancient times; hedge clippers work in essentially the same fashion as hand held models; even backhoes lend mere power to the digging of shovel blades or hoes. And so today, thousands of years since the beginnings of plant husbandry and home economics, people work the same basic implements, one implement at a time, and take to work each time the same array of hand held tools.

What is needed in the area of hand held tools for the garden is a single tool to loosen, dig, and furrow soil, to weed or plant effectively and efficiently with just one instrument, and to remove, replace, and cultivate plants without need of a box full of implements.

### SUMMARY OF THE INVENTION

Accordingly, it is an object of the invention to provide a single garden tool capable of performing many or all of the tasks faced by the gardener, the landscaper, or the planter.

It is a further object of the invention to provide in one instrument a tool for loosening, working, furrowing, trenching, digging, removing, and replacing soil; for setting or removing indoor or outdoor plants; for weeding; and for cutting roots or other objects.

It is another object of the invention to provide a hand held tool which will act as an extension of the hand, allowing the tool to perform many tasks while reducing bending stresses in the user's wrist.

It is another object of the invention to provide a blade for a garden tool which will allow the tool to be used for the setting and removal of bulbs and other plants without damaging the bulbs and plants.

It is another object of the invention to provide a tool capable of performing all of the above tasks without the necessity of the user shifting his or her grip upon the handle of the tool.

It is another object of the invention to provide a long lasting, durable, and reliable tool of the type described.

It is another object of the invention to provide a method of performing any or all of the above tasks with a single tool.

It is another object of the invention to provide the above described tool or tools at modest cost.

It is another object of the invention to provide tools of the type described above which do not require routine or complex maintenance.

It is a further object of the invention to provide a tool with a generally dished region and a tip region having a bifurcated point.

It is another object of the invention to provide a tool with serrated edge regions.

It is yet another object of the invention to meet any or all of the needs summarized above.

These and such other objects of the invention as will become evident from the disclosure below are met by the invention disclosed herein.

The invention addresses these needs and provides such a system. The invention represents a new versatility in garden or field working, and in garden or field working tools. The invention reduces the number and weight of tools required to perform most if not all of the tasks of gardening or horticulture and to accomplish all the essentials of plant husbandry, and provides new utility in the home previously lacking in conventional home tools.

The invention provides a multipurpose garden tool, and a method for indoor or outdoor gardening, planting, and soil working. The tool and method incorporate the capabilities of scooping, cutting, scraping, loosening, working, furrowing, trenching, digging, removing, and replacing household dirt or garden soil; of setting and removing plants; of weeding; of scraping, emptying, or cleaning planters, pots, and other gardening containers, especially those having tight corners; and of cutting and removing plant roots and other obstacles found in or around soil. This allows loosening, furrowing, digging, and excavating soil with a single tool.

In a tool aspect of the invention, one embodiment is a blade for a tool with a generally dished region and a bifurcated tip. The blade has a grip axis and the bifurcated point is offset from the grip axis by an offset distance. This offset distance is sometimes also called the clearance distance. Preferred embodiments of the blade are adapted to engage a handle at a handle end of the blade opposite from the tip point, and have at least one serrated edge region adjacent to the tip.

By referring to the blade as dished, or to a dished region, it is meant that the region includes a concavity, or a relatively dished portion. The dished region is generally located within the central portion of the blade between the handle end and the bifurcated tip; in preferred embodiments, the concavity is generally bounded by relatively curved or raised edges.

The dished region has a tip region with a bifurcated point, a periphery and a base point. The periphery has a tip region, and the base point lies at an end of the dished region generally opposite the tip region. In this embodiment, a substantial portion of the periphery lies below a tool reference plane passing through the tip point and the base point. This embodiment preferably also has a handle end at an end of the blade opposite from the tip point, and the handle end is particularly adapted to engage a handle. Preferably, the base point does not lie anywhere on the handle end.

In distinguishing the invention from other tools, it is useful to refer to the periphery of the dished region, the periphery generally being the more or less continuous edge or sum of edges of all of the edges, including serrated edges, of the dished region, generally not including any portion of a handle end of the blade. The periphery has a bifurcated point which is generally the same point as the tip point of the blade's tip region.

A handle end on a blade may preferably be adapted for engaging a handle to be fitted to the blade as described. However, the handle end of the blade is also any structural portion of the blade that is either particularly adapted to receive and engage a handle, or that is not particularly part of the dished region of the blade, such as by having no particular curvature of its own, or no curvature that is part of a curvature of the dished region. The blade also has a base point for defining a tool reference plane. The base point may be thought of as the point on the blade furthest from the tip point without venturing onto the handle end.

Pulling the tool through the soil may best be accomplished by pulling the tool toward the tool user in a direction along the grip axis. By way of illustration, it may readily be appreciated that a pull toward the user along the grip axis of a conventional trowel would be a useless action. The user may also employ a sawing motion with the tool to cut through roots or debris in the soil. To furrow some soil is to leave a furrow in it or alternatively to leave an elongate hole in the soil. As a user pulls the tool through the soil, having already gripped the tool with the hand to drive it into the soil, the user preferably does not have to change hand grip position or hand orientation on the grip or handle of the tool, and the grip axis of the tool does not have to be changed substantially, as for example it would have to be changed if the tool were a conventional trowel.

With a trowel, the driving motion would be a stabbing kind of motion into the soil, and the grip would be a stabbing grip. Furrowing with the trowel would then require both a change in hand grip and also a change in grip axis orientation (from near vertical to rather horizontal), and the furrowing then would still be push rather than a pull. Holding the trowel so as not to require such changes, would only allow a thrust away kind of driving into the soil, almost horizontal.

Inasmuch as it is generally to be expected that the tool will be held in a user's hand, the tool in preferred embodiments provides a handle or grip for the convenience of the user in handling or using the tool. The handle or grip is most usually located at an end of the blade opposite the tip; and, being of otherwise generally common configuration, the handle or grip serves to define, by means of the centers of its aggregated cross sections, an axis which might be referred to as the grip axis. For example, in embodiments provided with a straight, more or less conical or cylindrical handle or grip, such as might be found on a common trowel, the grip axis is identified as the axis running through the more or less circular cross sections of the handle; that is, down the center of the grip. It is this grip axis from which the tip of the invention, or a point provided on the tip, is offset. “Offset,” as used in this disclosure, means that the tip or the point of the blade is curved or deflected upward (colloquially, one might say that the tip or point was “bent” up or upward), out of the grip axis and away from the body of the blade. That is, if one were, for example, to take a common table spoon and bend the tip upward (“up” or “upward” in this sense meaning generally upward in the vertical direction when the tool or spoon is held upright in such a position that water would remain within its bowl or concavity) so that the tip passed out of the grip axis, the tip would be offset.

The distance by which the tip or the point of any particular embodiment of the invention is offset with respect to the grip axis depends upon the use to which the particular embodiment is to be put. Generally, the offset distance is at least that distance required to permit the user to drag the point of the tool along the ground or other excavant in the direction of the grip axis, with the grip axis more or less parallel to the excavant, without interference from any other portion of the tool or from the user's hand. That is, the tip or the point is generally minimally offset from the grip axis by a distance sufficient to clear the user's hand and all parts of the tool other than the tip or the point from interference with the ground or other excavant when the point is drawn along the excavant in the direction of the grip axis, with the grip axis being held more or less parallel to the excavant. Such a minimal distance or offset is referred to as a clearance distance.

For embodiments of the invention intended for general indoor or outdoor garden or indoor use, the preferred offset, or clearance distance, is that offset great enough to allow the tool to be used for loosening soil or other material and cutting roots or other fibrous material in the soil with the bifurcated point, and for furrowing or scraping the soil or other material with the bifurcated point, without interference from the remainder of the tool, or from the hand of the user, with the ground or other material.

Another aspect of the invention is a blade for a tool, also with a generally dished (or spoon shaped) region and a bifurcated tip, and with the bifurcated tip projecting generally away from the dished region. The blade has a periphery on the dished region, and the periphery has at least one serrated, or toothed, edge region.

Yet another aspect of the invention is a blade for a tool, and the blade has a region of curvature along a portion of its length and a region of curvature along a portion of its width, with the regions of curvature in the blade thereby forming a dished region. The dished region has edges and a periphery defined by its edges, and the periphery is serrated along a portion of the blade's length, and preferably proximate a center of the blade's length.

Another way of describing the shape of the dished region of the blade is to say that its curvature is comprised of a region of curvature along a substantial portion of the blade's length. Substantial portions are generally percentages of length greater than about 10& up to 100%, and preferably between 30% and 100%.

In those embodiments of the tool aspect of the invention having handles or grips, the grip or handle may be provided as an integral part of a handle end of the blade or in other conventional or nonconventional manner. In most cases, the handle will be provided at the handle end of the blade generally opposite the tip region, as is common with conventional garden tools. In many embodiments of the invention, the handle is short enough to allow the tool to be easily or comfortably manipulated, in the performance of most or many of the tasks described, with the use of a single hand. Other embodiments provide longer handles, so as to allow the tool to be worked with both hands, often with the hands spread sufficiently far to allow the user to apply a reasonable amount of leverage on the tool.

Embodiments of the tool aspect of the invention also provide one or more serrated regions along the edge of the blade. These serrated edge regions are used for cutting or otherwise loosening or removing the obstacles or debris commonly encountered in or about the home or garden or the soil, such as residue in corners, roots, embedded sticks, small rocks, or hard pan or clay soil.

Another aspect of the invention is the provision of a complete home or garden tool consisting of a handle and a blade, the blade having an offset pointed tip and a scoop portion. In this aspect the handle is fixed to or made integral with the blade in conventional or nonconventional fashion, and is adapted so that the user may perform a variety of tasks, such as driving the tip region downward into soil or other excavant to loosen it, furrowing, or otherwise excavating the excavant by dragging the tool back toward the user by the handle, and scooping soil out of the furrow or excavation, generally by thrusting the side of the blade into or under the loosened excavant, all without the user having to shift his or her grip on the handle.

Preferred embodiments of this aspect of the invention generally comprise an otherwise conventional, substantially straight handle fixed to one end of the blade adjacent to a generally concave or spoon shaped scoop portion of the blade, and, at an opposite end of the blade from the handle, a bifurcated pointed region, the offset of the pointed region being described generally in the same terms already set forth above. Such a configuration of the tool lends itself readily to the continuous, comfortable, convenient, and repetitious use of the tool for loosening, furrowing or otherwise digging or excavating soil or other excavants from deep or narrow holes, spaces, or containers, and removing the excavants in the manner described merely by gripping or grasping the tool by the handle, in the case of a straight handled embodiment of the invention, with the fingers wrapped around the handle in such a fashion as to leave the blade of the tool extending from the handle on the side of the grip nearest the tip of the thumb, and, holding the tool inverted in such fashion (“inverted” meaning the opposite of upward as described above), thrusting the tool tip down into the excavant, and loosening the excavant, working the tool front and back, sideways, or up and down, if needed, to do so, furrowing the excavant, if need be, by pulling the tool back toward the user along the axis of the handle (the grip axis previously defined), and scooping soil into the scoop portion of the blade by thrusting the blade sideways into or under the soil.

It may readily be seen that the tool described lends itself to a novel usage, when gripped in such fashion (i.e., without a necessity for the user to shift his or her grip on the handle between the described steps), in marked contrast to the usage that would be required with conventional spades or garden tools.

Provision of the blade of this aspect of the invention with a serrated edge region permits direct extension of the use of the tool to the sawing or cutting of roots or other obstacles or debris encountered when working soil or other materials. The user merely alternately thrusts the tool forward and pulls it back toward himself or herself, while holding the tool as previously described, with the serrated edge region held against the root or other obstacle, so that the serrations saw through, snag, or otherwise abrade or pull the obstacle until it is severed or otherwise loosened for removal. It may be readily seen that such sawing operations may be performed, like the loosening, furrowing, and scooping operations described above, without the necessity of the user shifting his or her grip upon the handle.

A further aspect of the invention lies in the use of a tipped hand garden tool in the manner generally described: by thrusting the tip of the tool downwardly into soil or other excavant, and working it back and forth, sideways, or up and down, if necessary, to loosen the excavant; pulling the tool back toward the user along the grip axis to furrow the excavant, and scooping excavant from the furrow or other excavation thus made to remove it. Generally, the furrowing portion of the method is accomplished by holding the tool in the manner described above and pulling it toward the body of the user along the grip axis of the handle.

Likewise, the method may optionally be extended to include sawing through or otherwise loosening or removing roots or other obstacles in the manner described, by engaging a serrated edge of the tool against the root or obstacle and alternately thrusting the tool forward and drawing it back against the root until it is severed or otherwise snagged or loosened.

It is readily seen that any or all of the above aspects of the invention might be employed equally well indoors or out, in fields, for agricultural or other horticultural purposes, or in smaller indoor or outdoor gardens, in the home and kitchen, and with garden, field or potted plants.

According to a still further aspect, the invention is a blade for a garden tool. The blade includes a generally dished region and a tip region at a first end. The tip region has a bifurcated point. The blade is adapted to engage a handle and has a grip axis at a second end opposite the first end. The blade further has at least one serrated edge region between the first and second ends.

According to yet another aspect, the invention is a method for making a blade for a garden tool. The method includes the step of a) forming a generally dished region from an integral sheet of material, the dished region having a grip axis at a second end opposite a first end. The method further includes the step of b) forming a tip region at the first end of the dished region, the tip region having a bifurcated point. The method further includes the steps of c) adapting the blade to engage a handle, and d) forming at least one serrated edge region between the first and second ends.

According to an additional aspect, the invention is a blade for a garden tool. The blade includes a generally dished region for holding a garden material and a tip means for entry into the garden material. The tip means is formed at a first end and has a bifurcated point means for cutting into the garden material when the tip means is forced into the garden material. The blade is adapted to engage a handle means for holding the blade. Also, the blade has a grip axis at a second end opposite the first end. The blade further has at least one serrated means for cutting the garden material when the blade is forced into the garden material, the at least one serrated means being between the first and second ends.

### BRIEF DESCRIPTION OF THE DRAWINGS

FIG. 1 is a side perspective view of a preferred embodiment of the invention.

FIG. 2 is a top view of a preferred embodiment of the invention.

FIG. 3 is a bottom view of a preferred embodiment of the invention.

### DETAILED DESCRIPTION OF THE PREFERRED EMBODIMENT OF THE INVENTION

For purposes of this disclosure, the terms “garden material” and “excavant” shall be construed to mean any material capable of being dug, shoveled, scooped, furrowed, loosened, or otherwise excavated. Examples of such materials include, without limitation, dirt, soil, gravel, and many food stuffs.

Turning now to the drawings, the invention will be described in a preferred embodiment by reference to the numerals of the drawing figures wherein like numbers indicate like parts.

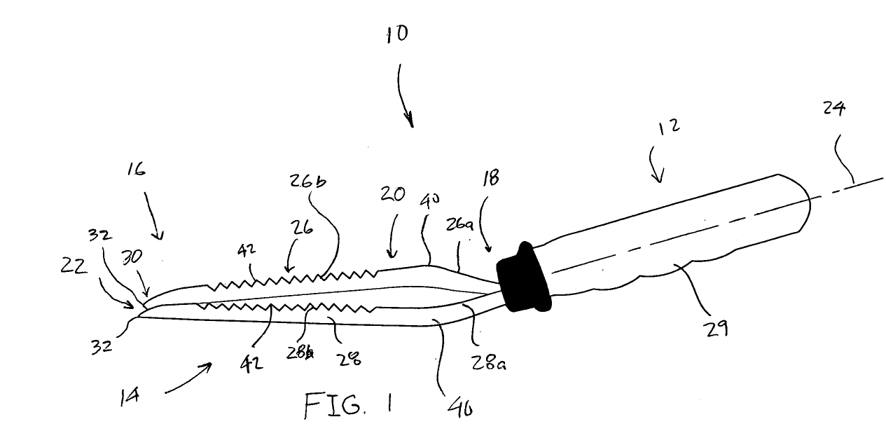

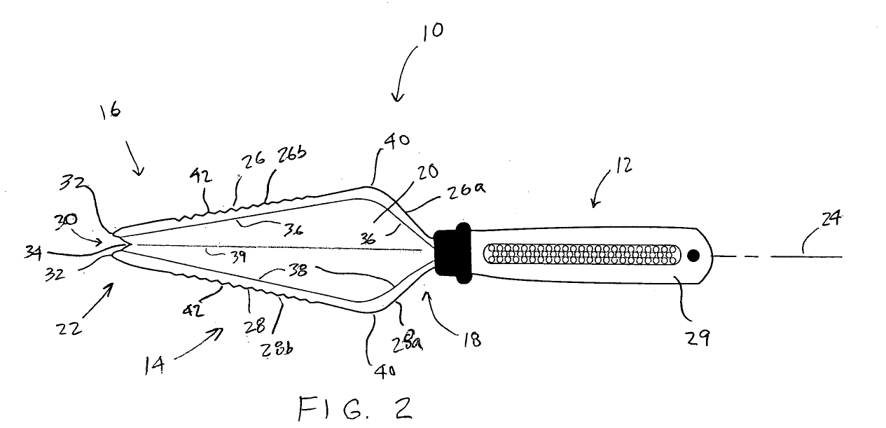

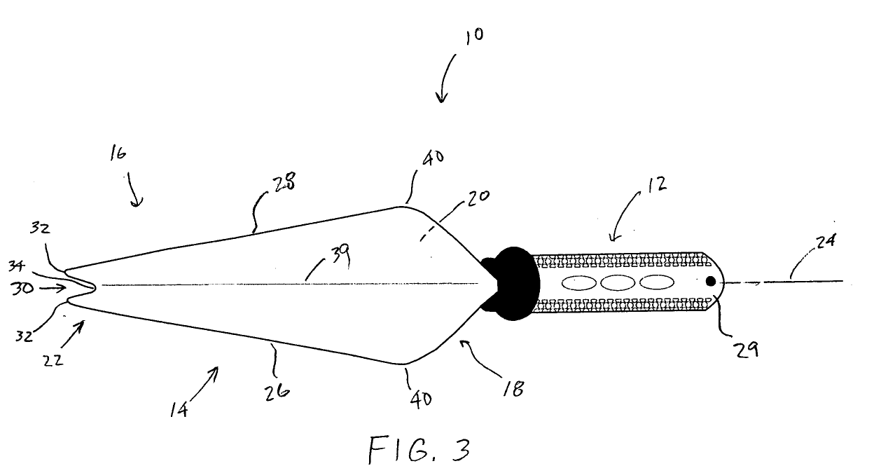

FIG. 1 is a side perspective view of a preferred embodiment of the invention, FIG. 2 is a top view of a preferred embodiment of the invention, and FIG. 3 is a bottom view of a preferred embodiment of the invention.

As shown in FIGS. 1-3, the garden tool 10 includes a handle 12 and a blade 14. The blade 14 has a first end 16 and a second end 18. The first and second ends 16 and 18 are opposite one another relative to the blade 14. The blade 14 includes a generally dished region 20 and a tip region 22 at the first end 16. The blade 14 also includes a grip axis 24 at the second end 18 and has edges 26 and 28 between the first and second ends 16 and 18. The second end 18 may comprise any combination of materials or shapes including special tapers or other shapings of one end of the blade 14 itself, which are aptly adapted, as will be appreciated by those skilled in the art, for engaging a conventional handle 29 to the blade 14. The handle 29 may or may not comprise a separate dedicated handle piece or assembly, but the handle 29 generally serves to define the grip axis 24, which runs more or less along the center of the handle 29 and the second end 18. The grip axis 24, therefore, defines the direction in which pulling or pushing forces are generally applied when the garden tool 10 is used, as shown in FIGS. 1-3. As may also be seen in FIGS. 1-3, the handle 29 is substantially concentric with the grip axis 24.

As is also shown in FIGS. 1-3, the blade 14 is sufficiently large and appropriately shaped to allow the scooping of substantial portions of various kinds of matter, such as soil after the soil has been loosened or otherwise prepared for removal. The size of the blade 14 will depend upon the application to which the tool is put, whether indoor or outdoor usage is contemplated, domestic or horticultural, and upon the size of the furrow, hole, or other excavation the tool is employed to make. For example, it will occur to the skilled designer of garden tools to make a relatively larger tool, according to the invention, for the purpose of setting medium to large sized plants than for digging narrow furrows for the planting of seeds or for many kitchen tasks such as scooping ice cream. Other particular blade or scoop sizes for a given application will also occur to those skilled in the art.

The edges 26 and 28 can be formed by any appropriate method, for example, by folding or forming them upwardly from the dished region 20 along lines 36 and 38. At least one of the two edges 26 and 28 is serrated along a portion of its length. Furthermore, the dished region 20 can be formed by folding the material between the edges 26 and 28 along a folding line 39.

The tip region 22 includes a bifurcated tip 30 that can have the shape of a fork defined by two extensions 32 separated and defined by an indentation 34 formed in the tip region 22. Those skilled in the garden tool arts will recognize that the extensions 32 and the indentation 34 cooperate to form a structure that is particularly suitable for cutting roots upon the application of sufficient force directed along grip axis 24.

As shown in FIG. 1, the tip region 22 is generally disposed at the opposite end of the blade 14 from the handle 29, and in generally preferred embodiments the tip region 22 is substantially offset from the generally dished region 20 of the blade 14. That is, the tip region 22 is offset by an offset distance, and in preferred embodiments angled up, or out, and away from the generally dished region 20, in such a manner as to allow the tip region 22 to both furrow soil without interference from the generally dished region 20 or other portions of the blade 14 or the garden tool 10, or from the hand of the tool user, when the tip region 22 is pulled through the soil by the tool user along the grip axis 24, whenever the grip axis 24 is parallel to the ground (horizontal). The tip region 22 is also angled and offset from the generally dished region 20 to pierce the surface of the excavant when the garden tool 10 is driven point down into soil or other material and to sink the tip region 22 to a working depth in the excavant, without the garden tool 10 being stopped or impeded by the generally dished region 20 or other portions of the blade 14 or of the tool, or by the hand and knuckles of the user. The offset distance is referred to as the clearance distance, i.e., the minimum distance between the extensions 32 and the grip axis 24.

A working depth to which the tip region 22 is to sink is that depth which will allow the user of the tool to make effective use of the tool in loosening the material into which the tip is driven, and thus would depend upon the quality of the soil and the purpose of the particular use. In loosening very hard packed, fine soil or clay, for example, a relatively shallow penetration of the tip (of the order of perhaps ½to 2 inches) would generally suffice, whereas for looser, more extensively clodded or moist soil penetrations would generally run deeper—more along the order of 1 to 3 inches. Because the depth to which the tip region 22 will be expected to penetrate materials will generally be somewhat smaller than the offset required to achieve it, due to the desirability of leaving a reasonable clearance between the soil surface and the lowest extremity of the tool or the user's hand, the clearance distance will therefore generally vary from approximately 1 to 4 inches, depending upon the size of the tool and the-particular application to which it is put.

Aside from being substantially offset from the blade 14, the tip region 22, and, more particularly, the extensions 32 and 34 and the indentation 34, may be shaped according to its immediate intended purpose. For tools intended for narrow furrowing or picking at hard pan or other packed or difficult soil, the extensions 32 and 34 may be sharply pointed. For working of looser soil, surface scraping, or the digging of broader furrows, or for some types of general kitchen work, the extensions 32 and 34 may be more rounded points.

The serrated regions of the edges 26 and 28 may in some embodiments be located on one or both of the edges 26 and 28 of the blade 14, between tip region 22 and the second end 18 or the handle 12, as shown in FIGS. 1 and 2. More specifically, as the edges 26 and 28 are traversed from the handle 12 to the tip region 22, each of the edges 26 and 28 initially expands outwardly from the grip axis 24 (forming respective rearward edges 26a and 28a) and then, after reaching a maximally extending region 40, the edges 26 and 28 converge inwardly toward the tip region 22 (forming respective forward edges 26b and 28b). In generally preferred embodiments, serrations 42 are provided between the tip region 22 and the maximally extending region 40, in order to facilitate sawing of roots or other debris while digging. The selection of a particular cutting geometry for the serrations themselves will occur to the skilled tool designer. Serrations may take any of a great variety of shapes, including those of common wood saws.

The handle 29, where provided, may be of any suitable type, many of which are conventional. Preferred embodiments employ straight, ferruled handles, as shown in FIGS. 1-3, but they may alternatively be of any type permitting either the application of pushing or pulling forces along grip axis 24, or hammer style swinging of the garden tool 10 so that the tip region 22 or extensions 32 may be driven into the ground with the direction of applied striking force on the soil perpendicular or substantially normal to the ground, while permitting scooping of soil without the necessity of substantially shifting the grip of the user upon the tool. Custom grips as will be understood in the relevant arts may also be provided. Moreover, a handle or grip may be attached to the blade in any suitable fashion, such as by riveting, gluing, bolting, or the like, or it may be provided as an integral portion of the blade itself. Selection of suitable handle or grip designs will occur to the skilled garden tool designer. Materials employed for the handle 29 are also conventional.

The tip region 22 of the blade 14 is sufficiently dished itself to allow the tip region 2, when the garden tool 10 is held with the grip axis 24 substantially vertically aligned and handle 29 uppermost, to hold or cradle soil, so that the soil may be extracted from a relatively deep, narrow hole. It will be understood immediately that the exact geometry, or the extent of required dishing, of the tip region 22 for the purpose of cradling soil in this manner will depend upon the nature of the soil material and the type of excavation a particular embodiment of the tool is intended to make. For example, less dishing will be required for removal of damp soil, or soil otherwise cohesive or disposed to cling, than for the removal of loose dry sand.

The blade aspect of the invention may be fashioned of any material of sufficient formability, resilience, durability, toughness, strength, flexibility, and corrosion resistance to suit the purpose or purposes of picking, furrowing, plowing, digging, and/or tunneling various soils and other excavants in any given climate and condition. Steels and other metals have been used in preferred embodiments. Stainless steel in particular has proven satisfactory; particularly, for embodiments designed for general indoor and outdoor gardening and planting, 16 gauge #304 brushed stainless steel. However, many plastics or other synthetic materials will also serve, as will be appreciated by those skilled in the art; even wood might be fashioned to serve. Depending upon the material selected, geometric factors may be exploited to tailor the strength stiffness, and durability of the tool to any purpose. Likewise, the tool (particularly the blade of the tool) may be formed by any suitable method, such as stamping, rolling, die cutting or stamping, or even forging.

Applicants herein incorporate by reference the disclosures of their earlier patent applications, Ser. No. 08/692,234, filed Aug. 6, 1996, and issued as U.S. Pat. No. 5,765,648; and Ser. No. 09/022,297, filed Feb. 11, 1998, and issued as U.S. Pat. No. 5,960,891.

With regard to aspects and components above referred to, but not otherwise specified or described in detail herein, the workings and specifications of such aspects and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

### INDUSTRIAL APPLICABILITY

The invention has applicability in the amateur and professional or commercial fields of horticulture, agriculture, and gardening, and in general home use. It greatly eases the burden of the homemaker, gardener, planter, or soil worker by reducing the number, weight, expense, and maintenance requirements of the tools required for his or her task, and the time required for the performance of the task. It may be inexpensively manufactured, and can be distributed and used throughout the world.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. A blade for a garden tool, the blade comprising a generally dished region and a tip region at a first end, the tip region having a bifurcated point, the blade being adapted to engage a handle and having a grip axis at a second end opposite the first end, the blade further having at least one serrated edge region between the first and second ends.

2. The blade of claim 1, wherein the at least one serrated edge region is adjacent the bifurcated tip.

3. The blade of claim 2, wherein the blade has a dished region between the first and second ends.

4. The blade of claim 3, wherein the at least one serrated edge region is adjacent the dished region.

5. The blade of claim 3, wherein the dished region has a folded axis extending between the first and second ends.

6. A method for making a blade for a garden tool, the method comprising the steps of:
a) forming a generally dished region from an integral sheet of material, the dished region having a grip axis at a second end opposite a first end,
b) forming a tip region at the first end of the dished region, the tip region having a bifurcated point,
c) adapting the blade to engage a handle, and
d) forming at least one serrated edge region between the first and second ends.

7. The method of claim 6, wherein the at least one serrated edge region is adjacent the bifurcated tip.

8. The method of claim 7, wherein step a)includes forming a dished region between the first and second ends.

9. The method of claim 8, wherein the at least one serrated edge region is adjacent the dished region.

10. The method of claim 8, wherein the dished region has a folded axis extending between the first and second ends.

11. A blade for a garden tool, the blade comprising a generally dished region for holding a garden material and a tip means for entry into the garden material, the tip means being formed at a first end, the tip means having a bifurcated point means for cutting into the garden material when the tip means is forced into the garden material, the blade being adapted to engage a handle means for holding the blade, the blade having a grip axis at a second end opposite the first end, the blade further having at least one serrated means for cutting the garden material when the blade is forced into the garden material, the at least one serrated means being between the first and second ends.

12. The blade of claim 11, wherein the at least one serrated means is adjacent the bifurcated point means.

13. The blade of claim 12, wherein the blade has a dished region between the first and second ends.

14. The blade of claim 13, wherein the at least one serrated means is adjacent the generally dished region.
